(19) United States
(12) Patent Application Publication
(10) Pub. No.: US 2023/0161680 A1
(43) Pub. Date: May 25, 2023

(54) BLIND NETWORKING

(71) Applicant: Arun Aftab, Cherry Hill, NJ (US)

(72) Inventor: Arun Aftab, Cherry Hill, NJ (US)

(21) Appl. No.: 16/873,948

(22) Filed: Aug. 25, 2020

Related U.S. Application Data
(60) Provisional application No. 62/973,409, filed on Oct. 4, 2019.

(51) Int. Cl. G06F 11/34

(52) U.S. Cl. CPC G06F 11/3438; G06Q 50/01

(57) ABSTRACT

The invention is a new technology in the area of social networking. It is a user initiated and user abortable online service, that accomplishes the website determined, real time or delayed, matching up of the members of a social network in individual to individual, individual to group and group to group settings at social events, venues and locations. It can be developed using any of the front end and back end programing languages and can incorporate a user location tracking software with or without a dynamic user data collection process.

### BACKGROUND OF THE INVENTION

As discussed previously in Application No. 62/973,409, Filed on Oct. 4, 2019, the invention is a new technology in the area of Social Networking.

As of now Human Interaction Websites can be categorized into two formats. The first is dating sites and the second is Online Social Networking sites, that are limited to facilitating user interaction on a computer screen.

### BRIEF SUMMARY OF THE INVENTION

This invention is an online service that can be offered to the members of a social networking site and which taps into the human instinct to intermingle with other individuals and not just a computer screen, but in actual and physical terms. It enables the members of a social network to interact with other members, not only in cyber-space but in-person/face to face in the outside world, irrespective of user location and without having to arrange the interaction themselves, as the service does it for them with a click of a button in either instantaneous (real time) or delayed formats.

### DETAILED DESCRIPTION OF THE INVENTION

This invention is a new technology that can offer consumers an improvement from the existing social networking experience, which is limited to facilitating user interaction on a computer screen.

It is a user initiated and user-abortable on-line service, that accomplishes the website determined, real time or delayed (as per the user's indication and suitability), matching up of the members of a social network in individual to individual, individual to group and group to group settings at social events, venues and locations.

The service can include “selective” and “random” matching options for users. And the matching of users occurs based on a specified list of criteria, which can remain constant or be changed as required. The events, venues and locations can be either site determined, or user determined, depending upon user's preference and suitability.

Users can be notified, status updated and surveyed through the Blind-Networking User App or through text messaging.

The technology can be developed using any of the Front-end and Back-end programing languages such as C#, VB, .net and JAVA, among others. The Front-end must be user interactive and the technology should be able to integrate camera and sound recording/playback functions.

A user data collection process that, after the initial uploading of info by the user, accumulates (dynamically) information about the user, the user's personality, habits, activities, likes and dislikes along with other information about the user and the user's environment feeds the matching function of the service.

The user's location can be pinpointed by tracking the user's smartphone, after a confirmation text message is returned to the service provided, by using Google Map, with an in-house built tracking technology or a different third party supplier. After this the user would get matched with other users based on the matching criteria and the user's location at the time.

1. The claimed invention is the website-determined, real time or delayed matching up of the members of a social network, in individual to individual, individual to group and group to group settings at social events, venues and locations.

2. A dynamic user-data accumulation system that tracks and reconciles a user's daily physical movements (time spent at each location) in addition to tracking on-line activity and credit card spending, through the user's smart phone, a wearable tracking device or an app in a smart phone.
